(19) United States
(12) Patent Application Publication
(10) Pub. No.: US 2014/0338167 A1
(43) Pub. Date: Nov. 20, 2014

(54) LIFT GATE WEDGE ASSEMBLY AND METHOD OF ASSEMBLY

(71) Applicant: Nicholas Jackson, JR., Davisburg, MI (US)

(72) Inventor: Nicholas Jackson, JR., Davisburg, MI (US)

(21) Appl. No.: 14/232,463

(22) PCT Filed: Jul. 13, 2012
(86) PCT No.: PCT/US12/46618

§ 371 Date: Jul. 28, 2014

Related U.S. Application Data
(60) Provisional application No. 61/507,192, filed on Jul. 13, 2011.

(51) Int. Cl. E05F 5/06; B60J 10/08

(52) U.S. Cl. CPC E05F 5/06; B60J 10/08
USPC 29/418

(57) ABSTRACT

A method of securing a wedge assembly to a vehicle is shown and described. The method may include the following steps: providing the wedge assembly having a striker assembly, a support assembly and a shipping retainer, securing the wedge assembly with a moveable door of the vehicle, engaging the moveable door of the vehicle with a door engaging portion of the vehicle, and adhering the support assembly with the door engaging portion of the vehicle in a predetermined position. The method may further include the following steps: disengaging the moveable door of the vehicle from engagement with the door engaging portion of the vehicle causing the shipping retainer to disengage from the striker assembly, and securing the support assembly with the door engaging of the vehicle.

### CROSS-REFERENCE TO RELATED APPLICATION

This application claims the benefit of U.S. Provisional Patent Application No. 61/507,192, entitled “Rear Lift Gate Wedge System,” filed on Jul. 13, 2011, which is hereby incorporated in its entirety by reference.

### FIELD OF INVENTION

This application relates generally to a lift gate wedge assembly and more particularly to a lift gate wedge assembly and a method for assembling the lift gate wedge assembly to a vehicle.

### BACKGROUND

Vehicles including automobile sport utility vehicles, station wagons, mini-vans, cross-over vehicles, cargo vans, trucks, and the like often provide an access door, commonly known as a lift-gate door. Other similar door designs include hatchback doors, sliding doors and horizontally swinging doors. Although these door designs can be mounted differently, for simplicity, these door designs will hereinafter be summarized in reference to lift-gate doors. Lift-gate doors are frequently hinged along an upper horizontal surface, and latch adjacent to a flooring system of the automobile, commonly adjacent to the rear fender of the automobile. One or more latches may be used. The side edges of lift-gate doors are generally not hinged or physically connected to the vehicle structure or support posts at the rear of the vehicle. Motion of the vehicle therefore can result in “match-boxing” or non-parallel deflection of the support posts relative to the squared sides of the lift-gate door.

Match-boxing is undesirable for several reasons. First, side-to-side or non-parallel motion of support posts can impart additional vehicle noise, known as “chucking” at the lift-gate latch as the vehicle travels along rough or uneven surfaces. Second, vehicle drive train vibration known as idle or “drive train boom” can be transmitted as noise into the passenger compartment via known sliding wedge designs. Third, unless a mechanism is positioned between the lift-gate door edge and the support posts of the vehicle, full structural allowance for the stiffness of the lift-gate cannot be used in the design of the support structure area.

In order to include the stiffness of the lift-gate door in the analysis and design of structural support posts, wedge assemblies have been used that displace to span the gap between the lift-gate door and the support post. These assemblies reduce match-box deflection of the support posts by transferring some deflection load to the lift-gate door using wedge assemblies generally positioned between each support post and the lift-gate door.

The wedge is typically a relatively small piece of elastomer, metal, or plastic attached to the liftgate or other appropriate location on a vehicle. Wedges are used to help stabilize the liftgate, especially to help prevent the liftgate from traveling cross-vehicle, fore/aft, and vertically during various vehicle body twist frequency sweeps. Wedges provide a load path from the liftgate to a frame of the vehicle body. Wedges also help to minimize the closing effort increase of the liftgate due to the reaction force in the swing-line direction. Still further, wedges help accommodate the gap and flushness variation between the liftgate and vehicle body due to manufacturing and assembly variations.

Common designs for wedge assemblies have several problems. One such problem is that vehicle rattling noise is produced if the wedge is not maintained in continuous contact with the striker plate (or vehicle support post). Tolerances used for common wedge assemblies permit easy translation, but can result in rattling between the parts during vehicle travel. Another problem is that vehicle build variation, vehicle manufacturing tolerances and/or frame vertical deflection during vehicle use can contribute to disconnect or result in lack of contact between the wedge and the striker plate (or vehicle support post). If the wedge is not maintained in contact with the vehicle support post or striker plate, rattling can occur. Yet another problem is that the hard plastic material commonly used for wedge designs may not dampen the vibration caused by the drive train during idle operation, thus further contributing to drive train boom.

One attempt at meeting the above requirements is to use a rubber block type wedge. In these vehicles, a rubber block is located in the gap between the liftgate and the vehicle body. However, this type of wedge may significantly increase the closing effort of the liftgate and may be hard to adjust to accommodate the gap variation.

Another attempt at stabilizing the liftgate is to use a spring loaded plastic bumper on each side of the liftgate, which would, in turn, mate with rubber stop pads. However, these bumpers and pads only provide cross-vehicle stabilization to prevent the liftgate from being excited beyond its own natural frequency into a state of impending motion. These bumpers and pads also require overslam bumpers to control movement in the fore/aft and up/down directions of the vehicle.

Therefore, it is desirable to provide a liftgate wedge assembly of a vehicle and method of assembly same that may stabilize the liftgate. It is also desirable to provide a liftgate wedge assembly of a vehicle and method of assembly same that may be adjustable to accommodate the gap and flushness variation between the liftgate and the vehicle body. It is further desirable to provide a liftgate wedge assembly of a vehicle and method of assembly same that may minimize the closing effort increase of the liftgate due to the reaction force in the swing-line direction. It is also desirable to provide a liftgate wedge assembly and method of assembly same that may be quickly assembled. Therefore, there is a need in the art to provide a lift gate wedge assembly of a vehicle and method of assembly same that meets one or more of such.

### SUMMARY

A method of securing a wedge assembly to a vehicle is shown and described. The method may include the following steps: providing the wedge assembly having a striker assembly, a support assembly and a shipping retainer, securing the wedge assembly with a moveable door of the vehicle, engaging the moveable door of the vehicle with a door engaging portion of the vehicle, and adhering the support assembly with the door engaging portion of the vehicle in a predetermined position. The method may further include the following steps: disengaging the moveable door of the vehicle from engagement with the door engaging portion of the vehicle causing the shipping retainer to disengage from the striker assembly, and securing the support assembly with the door engaging of the vehicle.

A method for securing a lift gate wedge assembly to a vehicle may include the steps of: securing a striker assembly of the lift gate wedge assembly with a lift gate of the vehicle, and closing the lift gate of the vehicle, where a support assembly of the lift gate assembly adheres with a lift gate engaging portion of the vehicle in a predetermined position. The method may further include the steps of: opening the lift gate of the vehicle, where a shipping retainer disengages from the striker assembly and the support assembly adhered to the lift gate engaging portion of the vehicle, and securing the support assembly with lift gate engaging portion of the vehicle.

A method for securing a lift gate wedge assembly to a vehicle may include the steps of: securing the lift gate wedge assembly with a lift gate of the vehicle, where the lift gate wedge assembly includes a striker assembly, a support assembly having an adhesive attached thereto and a shipping retainer selectively attaching the striker assembly with the support assembly. The method may further include the steps of: closing the lift gate of the vehicle, engaging the adhesive of the support assembly with a lift gate engaging portion of the vehicle, opening the lift gate of the vehicle, retaining the support assembly with the lift gate engaging portion of the vehicle in operative alignment with the striker assembly, disengaging the shipping retainer from the support assembly, and securing the support assembly with the lift gate engaging portion of the vehicle.

### BRIEF DESCRIPTION OF THE DRAWINGS

The operation of the invention may be better understood by reference to the detailed description taken in connection with the following illustrations, wherein:

FIG. 1 is a first and second exploded views of a lift gate wedge assembly and third and fourth perspective views of the lift gate wedge assembly;

FIG. 2 is a perspective view of the lift gate wedge assembly;

FIG. 3 is a perspective view of the lift gate wedge assembly with the striker assembly opened;

FIG. 4 is a perspective view of the lift gate wedge assembly with the striker assembly opened and the shipping retainer removed;

FIG. 5 is a perspective view of the lift gate wedge assembly with the striker assembly opened, the shipping retainer removed and a santoprene liner ready to be installed;

FIG. 6 is an exploded view of the lift gate wedge assembly;

FIG. 7 is an installed lift gate wedge assembly in the open position;

FIG. 8 is an installed lift gate wedge assembly in the closed position; and

FIG. 9 is a flow-chart depicting a method of installing the lift gate wedge assembly on a vehicle.

### DETAILED DESCRIPTION OF THE PREFERRED EMBODIMENTS

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

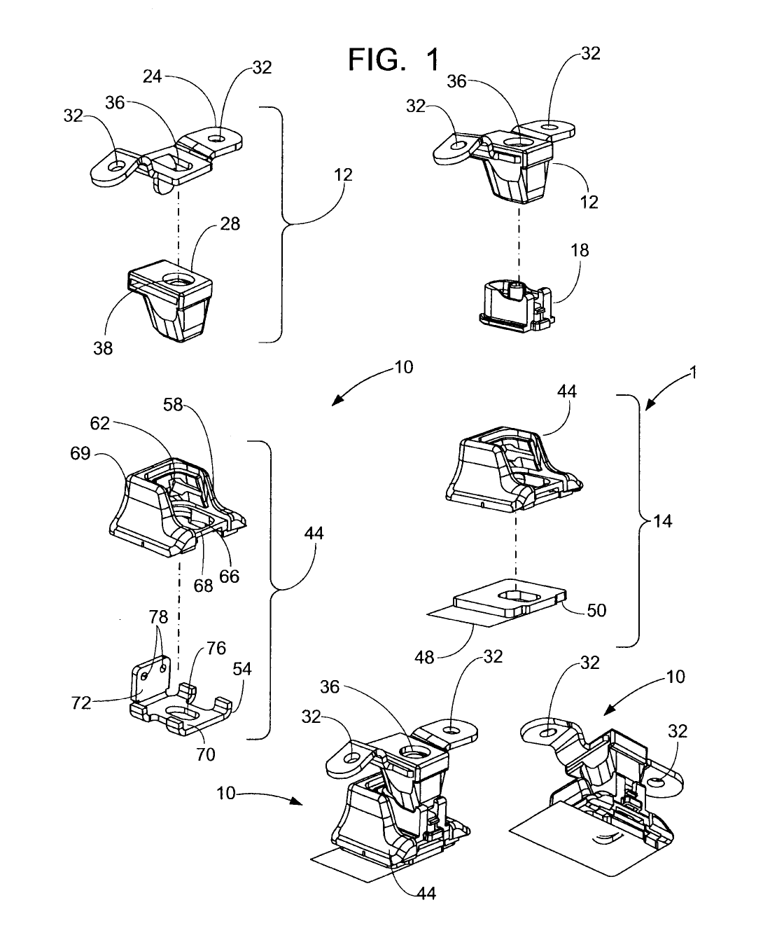

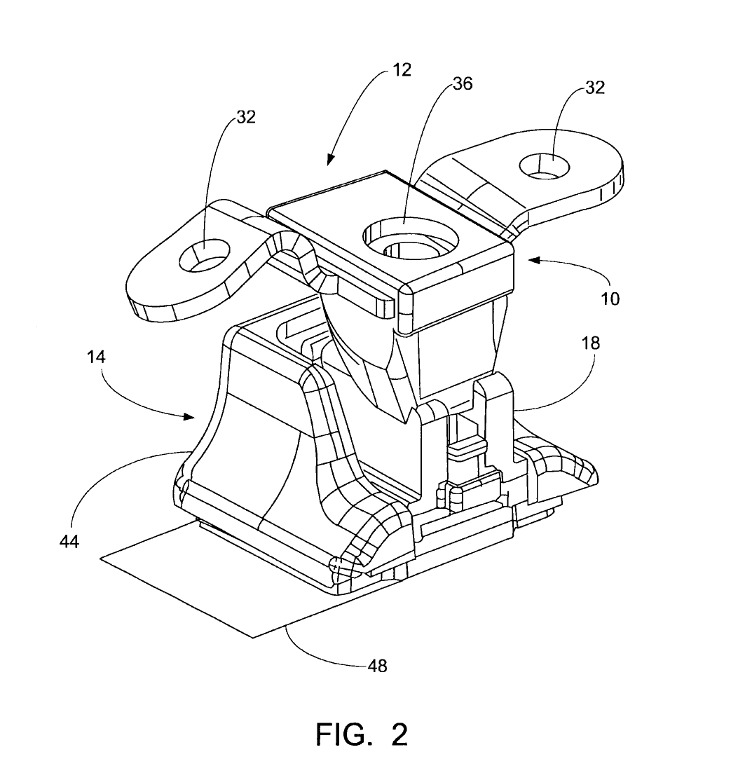

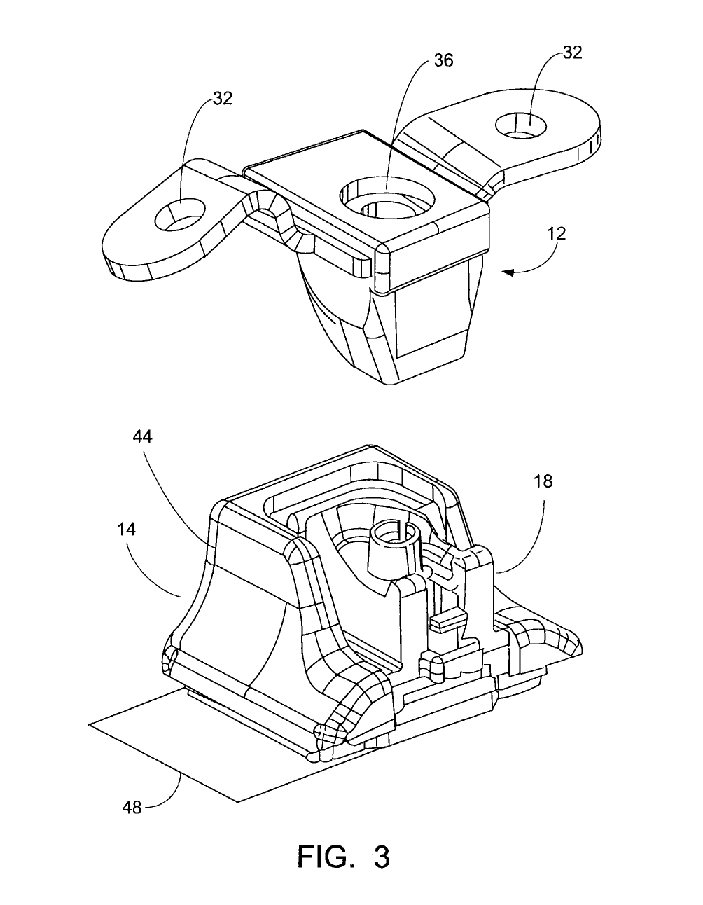

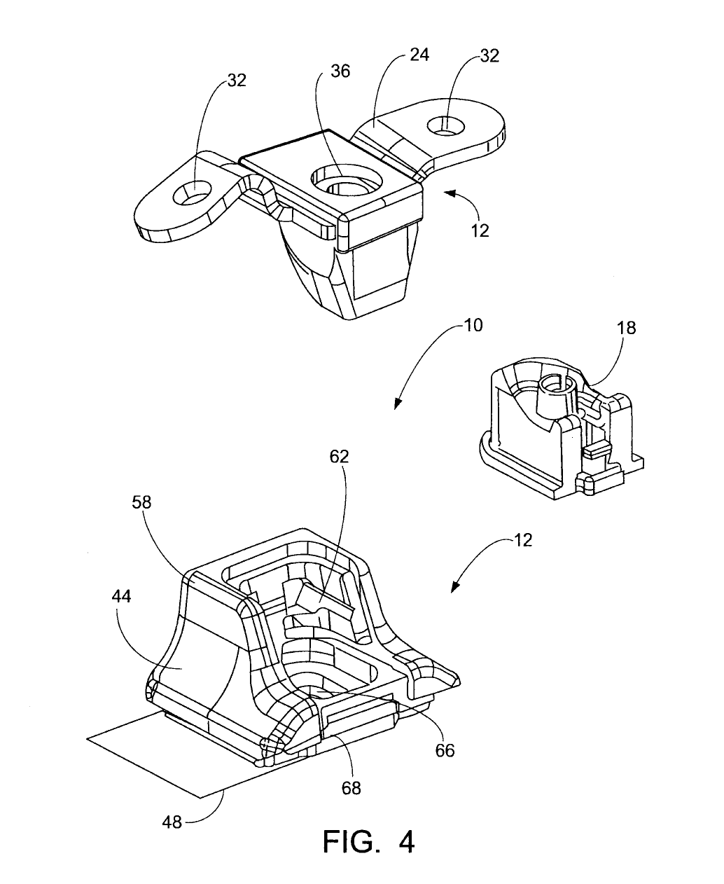

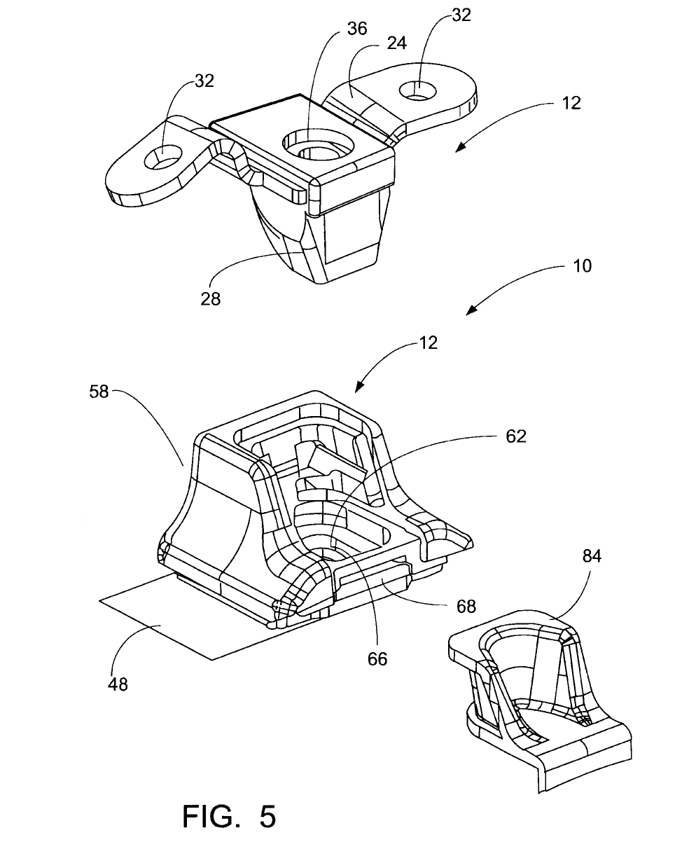

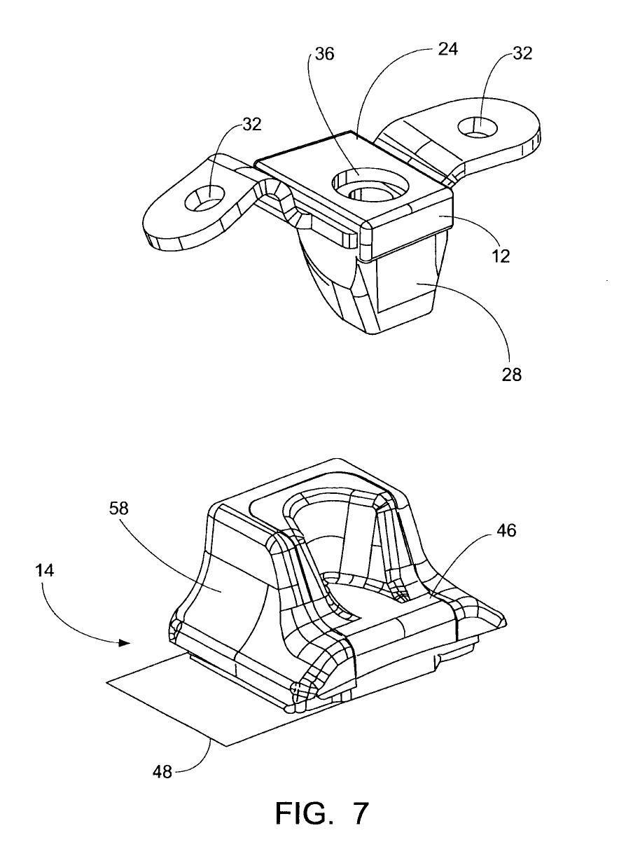

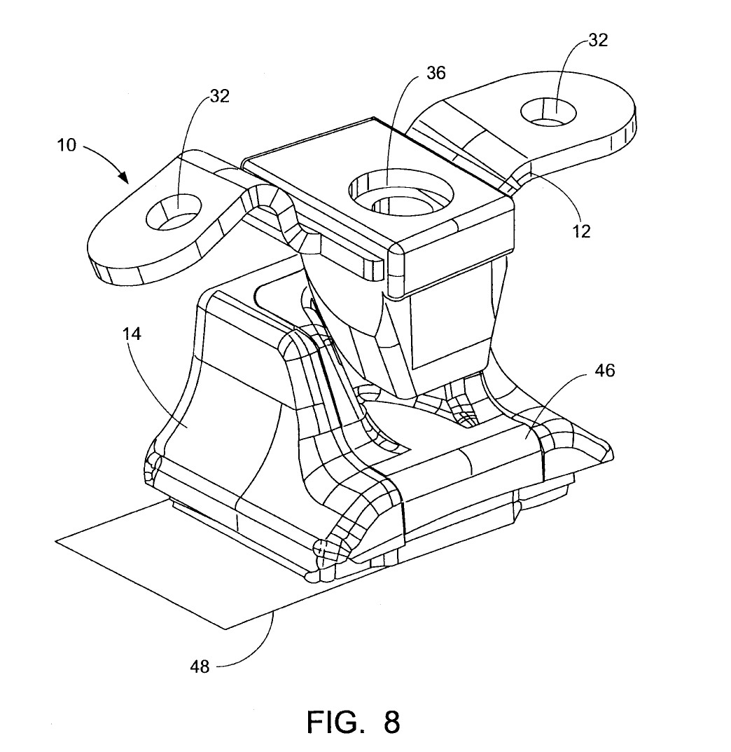

A lift gate wedge assembly 10 is shown in FIGS. 1 through 8. The lift gate wedge assembly 10 may be used on a rear-door of a vehicle, such as sport utility vehicles, station wagons, mini-vans, cross-over vehicles, cargo vans, trucks, and the like. The lift gate wedge assembly 10 may also be used on other similar door designs, which may include by way of a non-limiting example, hatchback doors, sliding doors and horizontally swinging doors. The lift gate wedge assembly 10 may include a striker assembly 12, a support assembly 14, and a shipping retainer 18, exemplary embodiments of which are shown assembled in FIG. 2.

Incidentally, it will be appreciated that this lift gate wedge assembly 10 may use fewer components than prior art lift gate wedges, may provide for substantially perfect alignment from lift gate to quarter panel on the initial attempt, and may prevent substantially all rattling of the lift gate to which it attaches. Compared to prior art left gate wedges, this lift gate wedge assembly 10 may provide for a speedier assembly time to the vehicle.

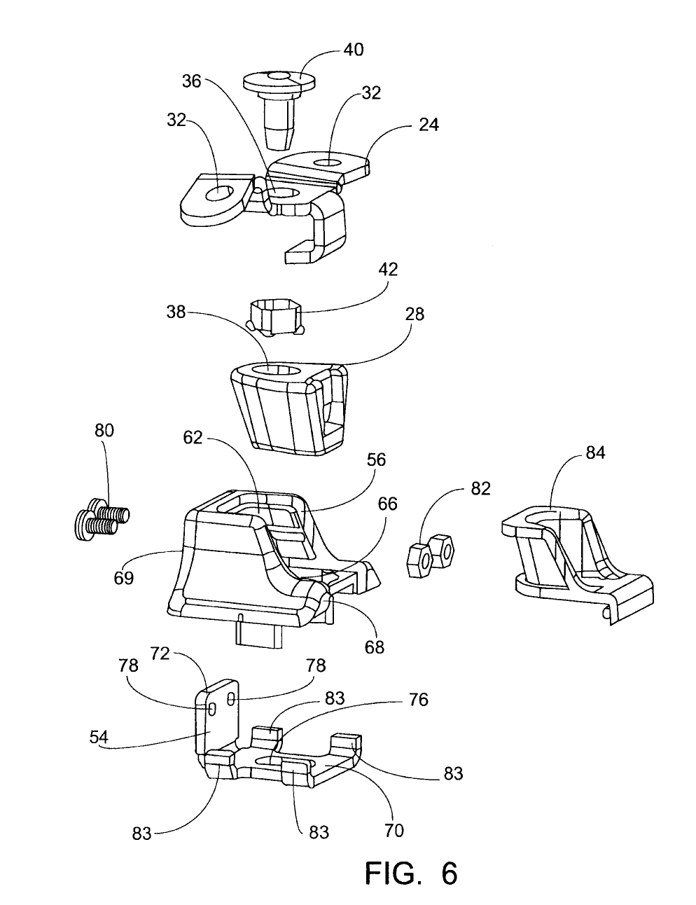

The striker assembly 12 may be comprised of wedge bracket 24 and a wedge 28 as shown in FIGS. 1 and 6. The wedge bracket 24 may be made of any appropriate material, such as of a substantially hard polymeric material. The present teachings, however, are not limited to the specific material—any appropriate material may be used. The wedge bracket 24 may include at least one vehicle securement aperture 32 and a wedge securement aperture 36. While three such apertures are shown and described, any number of apertures may be used without departing from the present teachings. Still further, while the vehicle securement and wedge securement apertures 32, 36 are shown as being generally circular apertures, the present teachings are not limited to such. The vehicle securement and wedge securement apertures 32, 36 may be of any generally appropriate shape, such as rectangular, oval, ovoid, or any combination of such.

The wedge securement aperture 36 may be located generally near a central portion of the wedge bracket 24. The vehicle securement apertures 32 may be generally located on a periphery of the wedge bracket 24, i.e., they may be located on respective ends of the wedge bracket 24 laterally spaced from one another. The vehicle securement apertures 32 may allow for any appropriate fasteners such as screws, self-tapping screws, self-tapping bolts, and any other fastener to engage with the vehicle, including by way of a non-limiting example into the lift gate of the vehicle such as through apertures thereon. The wedge bracket 24 may be of a shape as shown in FIG. 6 or of any other appropriate shape, such as substantially rectangular, circular, oval, square, etc.

The wedge 28 may be comprised of any appropriate material, such as by way of a non-limiting example an elastomeric material including, but not limited to, rubber, neoprene, silicon rubber, elastically deformable polymeric material, or the like. The wedge 28 may be of a shape as shown in FIG. 6 or of any other appropriate shape such as substantially rectangular, circular, oval, square, etc. The wedge 28 may include an aperture 38 located near a center portion of the wedge 28. Although, it should be understood that the aperture 38 may be located at any appropriate position. The wedge bracket 24 may be placed over the wedge 28 with the wedge securement aperture 36 generally aligning with the aperture 38 of the wedge 28 to allow any appropriate fastener 40 to be secured thereto. In some embodiments, the fastener 40 may be a bolt that maybe inserted into and through the wedge securement aperture 36 and into the aperture 38 of the wedge. A nut 42 may be used to secure with the fastener 40. This may secure the wedge 28 with the wedge bracket 24 forming the striker assembly 12.

The support assembly 14 of the lift gate wedge assembly 10 may include a base assembly 44, an adhesive pull tab 48 operatively connected with the base assembly 44, and an adhesive seal 50 connected between the pull tab 48 and the base assembly 44. The base assembly 44 may include a base support bracket 54 and an over molded base 58 as shown in FIG. 1. The base 58 may be comprised of a substantially hard polymeric material but may also be comprised of any other appropriate material. The base 58 may be of a shape as shown in FIG. 1 or may be of any other appropriate shape such as substantially rectangular, circular, oval, square, etc. As shown in FIG. 1, the base 58 may include an opening or a cavity 62 that may allow for the shipping retainer 18, the striker assembly 12, and a santoprene liner 46 to be placed inside the base 58, as described in more detail below. The base 58 may include an aperture 66 at any appropriate location thereof. By way of a non-limiting example, the aperture 66 may be located in proximity to a central portion on a lower portion 68 of the base 58. The aperture 66 may allow for at least one fastener (not shown) such as screws, self-tapping screws, self-tapping bolts, and any other fastener to engage with the vehicle, such as by way of a non-limiting example, a threaded aperture on the vehicle. This may secure the support assembly 14 with the vehicle. The base 58 may also include at least one additional aperture (not shown) positioned on a back wall 69 of the base 58. In some embodiments, the back wall 69 may include a pair of apertures (not shown), which is described in more detail below.

The base support bracket 54 may be comprised of any appropriate materials, including by way of a non-limiting example, a substantially hard polymeric material. The base support bracket 54 may comprise a shape shown in FIG. 1 or be comprised of any other appropriate shape, such as substantially rectangular, circular, oval, square, etc. The base bracket 54 may include a generally planar bottom member 70 and a vertically extending member 72 that may be generally perpendicular the generally planar bottom member 70. In some embodiments, the generally planar bottom member 70 and vertically extending member 72 may be integrally formed as a monolithic member or may be attached together through a subsequent operation.

The generally planar bottom member 70 may include at least one aperture 76 at any appropriate position, such as by way of a non-limiting example at a generally central location. The aperture 76 may be of any appropriate shape and size such that it may allow at least one fastener such as a screw, self-tapping screw, self-tapping bolts and any other appropriate fastener to threadably engage with the vehicle, such as by way of a non-limiting example, a threaded aperture on the vehicle. More specifically, the base support bracket 54 may be juxtaposed—such as being placed below—the base 58 with the base bracket aperture 70 generally aligning with the aperture 58 of the base 58. This may allow the fastener (not shown) to be inserted therethrough and then to be secured with the vehicle, which forms the base assembly 44.

The vertically extending member 72 of the base support bracket 54 may include at least one aperture 78. In some embodiments, the vertically extending member 72 may include a pair of apertures 78. It should be noted, however, that any appropriate number of such apertures 78 may be used without departing from the present teachings. A corresponding number of fasteners 80 may be used to engage apertures 78, i.e., if a pair of apertures 78 are used a pair of fasteners 80 may be used.

The base support bracket 54 may be generally aligned with the base 58. The apertures (not shown) of the back wall 69 of the base 58 may be generally aligned with the apertures 78 of the vertically extending member 72. The fasteners 80 may be inserted through the apertures 78 and through the apertures (not shown) of the back wall 69. A pair of nuts 82 may be used to threadingly engage the fasteners 78, which secures the base support bracket 54 with the base 58. Alternatively, in some embodiments, the nuts 82 may not be used and the fasteners 80 may attach directly to the base support bracket 54 and base 58. Still further, while apertures 78 and the apertures (not shown) of the back wall 69 are described, the fastener 80 may attach directly to the base support bracket 54 and base 58 without the use of apertures.

In some embodiments, the base support bracket 54 may include a plurality of tabs 83. The tabs 83 may be capable of engaging the base 58 when the base support bracket 54 is positioned adjacent the base 58. The tabs 83 may assist with positioning the support bracket 54 relative to the base 58 so that they may be secured together as described above. Still further, the tabs 83 may engage the base 58 further securing the base support bracket 54 with the base 58.

In such embodiments, a liner 84 may be inserted into the base 58. The liner 84 may be made of any appropriate material such as an elastomeric material such that it may provide dampening during operation of the lift gate wedge assembly 10. By way of a non-limiting example, the liner 84 may be made of santoprene—though the present teachings are not limited to such.

As previously noted, the support assembly 14 may include the adhesive seal 50 and the adhesive pull tab 48. As shown in FIGS. 2-5, the adhesive seal 50 may be positioned between the base assembly 44 and the adhesive pull tab 48. In exemplary embodiments, the adhesive seal 50 may attach to an underside of the base assembly 44, such as by way of a non-limiting example, using adhesives, fasteners, or the like. The adhesive pull tab 48 may be made of any suitable material, such as any kind of plastic, rubber or the like. The adhesive seal 50 may be made of any appropriately strong adhesive.

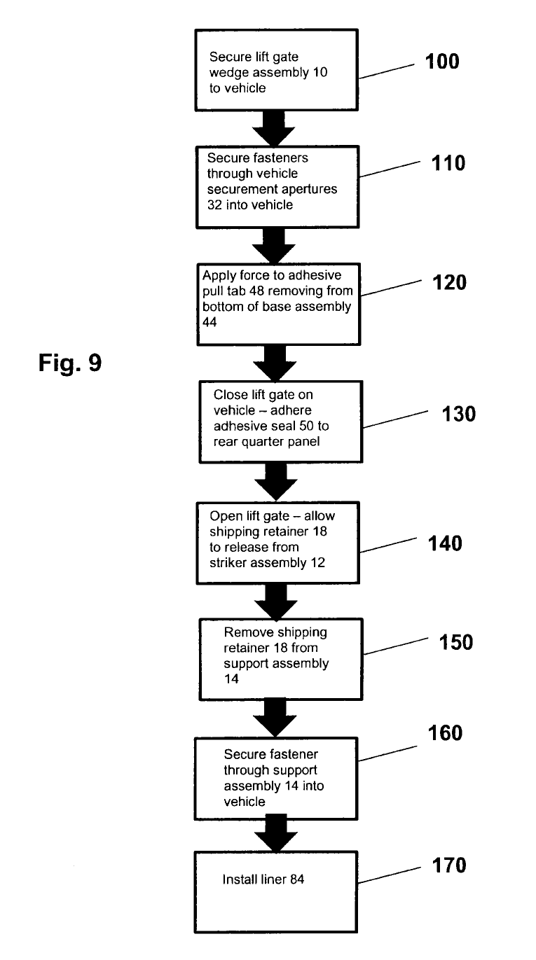

By way of illustration, a method for assembling the lift gate wedge assembly 10 to a vehicle is depicted in FIG. 9. The lift gate wedge assembly 10 may be assembled. Specifically, the striker assembly 12 may be formed, the support assembly 14 may be formed, and the support assembly may be formed. By way of a non-limiting example, the striker assembly 12 may be formed by securing the wedge bracket 24 with the wedge 28. The fastener 40 may be inserted into and through the wedge securement aperture 36 of the wedge bracket 24. The wedge 28 may be aligned with the wedge bracket 24 such that the fastener 40 may be inserted into and through the wedge aperture 38. The nut 42 may then be threadingly engaged with the fastener 40 securing the wedge bracket 24 with the wedge 28. This may form the striker assembly 12.

At least a portion of the base assembly 44 may be formed by securing the base support bracket 54 with the base 58. By way of a non-limiting example, the base support bracket 54 may be aligned with the base 58. The tabs 83 of the base support bracket 54 may engage the base 58 further aligning the apertures 72 of the generally planar bottom portion 70 of the base support bracket 54 with the aperture 66 of the base 58. In like manner, the apertures 78 of the vertically extending member 72 may align with the apertures of the back wall 69 of the base 58. The fasteners 80 may be inserted into and through apertures 78 and the apertures of the back wall 69. The nuts 82 may be threadably engaged with the fasteners 80 securing the base support bracket 54 with the base 58.

Further, the adhesive seal 50 and the adhesive pull tab 48 may be appropriately attached to the base assembly 44, which may form the support assembly 14. The adhesive pull tab 48 may be selectively attached with the adhesive seal 50, such that the adhesive pull 48 may be removed from the adhesive seal 50 as described below. The adhesive seal 50 may be added to an underside of the base assembly 44 and then the adhesive pull tab 48 may be attached with the adhesive seal 50 such that the adhesive seal 50 is positioned between the base assembly 44 and the adhesive pull tab 48.

Still further, the shipping retainer 18 may be selectively attached to both the striker assembly 12 and the support assembly 14 in any appropriate manner. This may result in the shipping retainer 18 selectively attaching the striker assembly 12 with the support assembly 14 forming the lift gate wedge assembly 10.

As depicted in FIG. 9, the lift gate wedge assembly 10 may be secured to a lift gate (not shown); shown as step 100. Specifically, the fasteners (not shown) may be inserted into and through the vehicle securement apertures 32 of the wedge bracket 24; shown as step 110. The fasteners may then be secured to the lift gate of the vehicle. This may secure the wedge bracket 24 with the lift gate of the vehicle. As the shipping retainer 18 selectively secures the striker assembly 12 with the support assembly 14, the lift gate wedge assembly 10 is therefore secured to the lift gate of the vehicle.

After the lift gate wedge assembly 10 is secured to a lift gate (not shown), the adhesive pull tab 48 on the adhesive seal 50 may be removed therefrom. A force may be applied to the adhesive pull 48 pulling it from securement with the adhesive seal 50; shown as step 120. The lift gate may then be closed; shown as step 130. This may allow the adhesive seal 50 to securely adhere to the rear quarter panel (not shown) of the vehicle.

Next, the lift gate may be opened; shown as step 140. This may allow the shipping retainer 18 to release from the lift gate wedge assembly 10, or more specifically, it may release from selective attachment with the striker assembly 12. This may occur as the adhesive seal 50 may have a greater retention force to the rear quarter panel (not shown) of the vehicle than the shipping retainer 18 may have with the striker assembly 12. This may result in the support assembly 14 remaining secured to the rear quarter panel of the vehicle while the striker assembly 12 remains fixed with the lift gate. After this is completed the support assembly 14 may be in position to receive the striker assembly 12, i.e., the support assembly 14 may be generally perfectly aligned with the striker assembly 12 despite the support assembly 14 being secured with the rear quarter panel and the striker assembly 12 being secured with the lift gate. Still further, the support assembly 14 may not need any additional positioning to be operatively aligned with the striker assembly 12 during closure of the lift gate.

Then, as shown in FIG. 9, the shipping retainer 18 may be removed from the support assembly 14 and be discarded; shown as step 150. A material fastener (not shown), such as a bolt, may then be driven through the aperture 60 of the base 58 and the aperture 76 of the generally planar bottom portion 70 of the base support bracket 54. This may secure the support assembly 14 to the vehicle (not shown); shown as step 160. The adhesion of the adhesive seal 50 may maintain the support assembly 14 in its current position, which assists in providing a substantially perfect alignment from lift gate to quarter panel on the initial attempt. The adhesive seal 50 may be compressed by the fastener being driven through the support assembly 14 into the vehicle, which may increase the force by which the support assembly 14 attaches to the vehicle.

Next, as shown in FIG. 9, the liner 84 may be installed into the support assembly 14; shown as step 170. The liner 84 may cover the fastener (not shown) that retains the support assembly 14 to the vehicle as described above. In addition the liner 84 may provide a soft contact area for the lift gate wedge assembly 10 when the striker assembly 12 is closed and engages the support assembly 14. Specifically, the liner 84 may act as a dampener, which may reduce the chucking noise and/or match boxing. This may increase the efficacy of the lift gate wedge assembly 10.

While the steps of the present method are shown as being performed in a specific order, the present teachings are not limited to the method being performed in this specific order. The steps may be performed in any appropriate order and are not limited to that shown and described above. By way of a non-limiting example, steps may be performed in a different order, certain steps may be skipped, certain steps may be combined, and additional steps may be added without departing from the present teachings. Still further, while the steps above describe a lift-gate door, the present method may also apply to similar door designs, including, without limitation hatchback doors, sliding doors and horizontally swinging doors.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, I claim:

1. A method for securing a wedge assembly to a vehicle, the method comprising the steps of:
providing the wedge assembly having a striker assembly, a support assembly and a shipping retainer;
securing the wedge assembly with a moveable door of the vehicle;
engaging the moveable door of the vehicle with a door engaging portion of the vehicle;
adhering the support assembly with the door engaging portion of the vehicle in a predetermined position;
disengaging the moveable door of the vehicle from engagement with the door engaging portion of the vehicle causing the shipping retainer to disengage from the striker assembly; and
securing the support assembly with the door engaging of the vehicle.

2. The method of claim 1, further comprising the step of attaching a liner with the support assembly, the liner dampening contact between the striker assembly and the support assembly.

3. The method of claim 1, wherein the predetermined position operatively aligns the support assembly with the striker assembly free of additional positioning of the support assembly and striker assembly.

4. The method of claim 1, wherein the support assembly includes an adhesive attached to an underside of the support assembly.

5. The method of claim 4, wherein the support assembly including the adhesive includes a pull tab removably attached to the adhesive.

6. The method of claim 5, further comprising the step of removing the pull tab from the adhesive before the step of engaging the moveable door of the vehicle with the door engaging portion of the vehicle.

7. The method of claim 6, wherein the adhesive adheres the support assembly with the door engaging portion of the vehicle.

8. A method for securing a lift gate wedge assembly to a vehicle, the method comprising the steps of:
securing a striker assembly of the lift gate wedge assembly with a lift gate of the vehicle;
closing the lift gate of the vehicle, wherein a support assembly of the lift gate assembly adheres with a lift gate engaging portion of the vehicle in a predetermined position;
opening the lift gate of the vehicle, wherein a shipping retainer disengages from the striker assembly and the support assembly adhered to the lift gate engaging portion of the vehicle; and
securing the support assembly with lift gate engaging portion of the vehicle.

9. The method of claim 8, further comprising the step of engaging a fastener with the striker assembly and the lift gate of the vehicle securing the striker assembly to the lift gate.

10. The method of claim 8, wherein an adhesive attached to the support assembly adheres and retains the support assembly to the lift gate engaging portion after opening the lift gate of the vehicle in the predetermined position.

11. The method of claim 10, further comprising the step of exposing the adhesive before closing the lift gate of the vehicle.

12. The method of claim 11, wherein the step of exposing the adhesive includes removing a cover from the adhesive before closing the lift gate of the vehicle.

13. The method of claim 8, further comprising the step of securing a dampening liner with the support assembly.

14. The method of claim 13, wherein the striker assembly includes a wedge capable of engaging the dampening liner of the support assembly.

15. The method of claim 14, wherein the predetermined position operatively aligns the dampening liner of the support assembly with the wedge of the striker assembly free of additional positioning.

16. A method for securing a lift gate wedge assembly to a vehicle, the method comprising the steps of:
securing the lift gate wedge assembly with a lift gate of the vehicle, wherein the lift gate wedge assembly includes a striker assembly, a support assembly having an adhesive attached thereto and a shipping retainer selectively attaching the striker assembly with the support assembly;
closing the lift gate of the vehicle;
engaging the adhesive of the support assembly with a lift gate engaging portion of the vehicle;
opening the lift gate of the vehicle;
retaining the support assembly with the lift gate engaging portion of the vehicle in operative alignment with the striker assembly;
disengaging the shipping retainer from the support assembly; and
securing the support assembly with the lift gate engaging portion of the vehicle.

17. The method of claim 16, wherein an adhesive attached to the support assembly retains the support assembly with the lift gate engaging portion in operative alignment with the striker assembly upon opening of the lift gate.

18. The method of claim 17, wherein the adhesive has a greater retention force to the lift gate engaging portion than the shipping retainer has with the striker assembly.

19. The method of claim 16, further comprising the step of securing a dampening liner with the support assembly, wherein the striker assembly operatively aligns with the dampening liner upon closing of the lift gate.

20. The method of claim 19, wherein the striker assembly includes a wedge capable of engaging the dampening liner of the support assembly upon closing of the lift gate.
